(19) United States
(12) Patent Application Publication
(10) Pub. No.: US 2014/0019273 A1
(43) Pub. Date: Jan. 16, 2014

(54) Foreign Language and Currency Calculator and Method of Facilitating Transactions in a Foreign Currency at the Point of Sale

(71) Applicant: Jeffrey Sprowl, Stone Mountain, GA (US)

(72) Inventor: Jeffrey Sprowl, Stone Mountain, GA (US)

(21) Appl. No.: 14/030,258

(22) Filed: Sep. 18, 2013

Related U.S. Application Data
(60) Provisional application No. 61/764,010, filed on Feb. 13, 2013.

(51) Int. Cl. G06Q 20/20; G06F 17/28

(52) U.S. Cl. CPC G06Q 20/20; G06F 17/28
USPC 705/16

(57) ABSTRACT

A method of facilitating transactions at the point of sale using foreign currency is provided. The method includes use of a handheld electronic device to receive voice input to discern the costs and the anticipated change to be returned from a clerk during a transaction for goods. A handheld device is utilized to receive voice input from the clerk in a foreign language, calculates the currency amount required to be paid by the user, and displays the required currency on its display screen, both in written words and in visual terms using dominations of the local currency. Voice inputs are then received from the user to determine the amount of currency given to the clerk, whereafter the amount of change anticipated from the transaction is visualized on the display for the user. The method facilities transparent transactions in foreign countries and helps teach foreign language skills in the process.

### CROSS REFERENCE TO RELATED APPLICATION

This application claims the benefit of U.S. Provisional Application No. 61/764,010 filed on Feb. 13, 2013, entitled “Watch It, Learn It, Say it.” The above identified patent application is herein incorporated by reference in its entirety to provide continuity of disclosure.

### BACKGROUND OF THE INVENTION

1. Field of the Invention

The present invention relates to currency calculators and determining currency required in a transaction when traveling abroad. More specifically, the present invention relates to a system for calculating currency required for a transaction based on speech and visual input, providing a user with the ability to pay for goods and services without being acquainted to the local language or the currency itself. Also provided is an associated method that utilizes speech and visual input to determine currency for a transaction and displays the necessary information to the consumer at the point of sale.

Traveling abroad can be an enjoyable journey with many rewards; it can also be a daunting experience if the local language and the local currency are not well understood by the traveler. Making simple transactions can be difficult, as the goods must be requested from the merchant and then paid for at the point of sale while interacting with individuals (e.g. clerks, merchants, etc.) in a foreign language and using a currency that is not readily known. The denominations of currency may be different from what the traveler is used to, its physical form may be different (e.g. large denomination coins, for instance, or paper money), its actual costs in terms of the traveler's native currency may also be difficult for the traveler to easily compute, and having enough knowledge of local customs and exchanges to ensure the transaction goes smoothly and without fraud is difficult for a traveler to keep in check without assistance.

Conducting a transaction for goods or services involves knowledge of the funds required and the reasonable cost of the goods to be exchanged or services to be provided. For travelers, it is imperative to maintain a budget and to ensure that funds are being spent appropriately with regard to the costs in the traveler's native currency. Making sure the transaction occurs smoothly is also desired. However, maintaining a balance between these competing interests is difficult at the point of sale, as there are many factors to be considered. The traveler must correctly communicate with merchants, pay the correct funds in local currency without undue delay or difficulty, ensure the correct amount of change is received in return for the funds provided to the merchant, and even interact with the merchant in a manner that is appropriate given the local customs. Local customs may dictate tipping for service, or even a level of bartering for the goods to be purchased.

Understanding these factors reduces tension and hardship on the traveler, but requires knowledge of the local currency, the language, and the customs. Without assistance or inherent knowledge, the traveler's interests may be placed in jeopardy. The traveler's budget may not be adhered to, the traveler may become discouraged and not enjoy the experience, and further the traveler may expose himself to fraud or deceptive dealings on the part of local merchants and salesman. Therefore, it is submitted that a means of assistance during foreign transactions at the point of sale is desired, both to improve communication and to prevent exposure of the traveler to risks. Improving communication also facilitates a smooth transaction without undue delay to other customers, or in a manner that may otherwise draw attention to the foreign traveler.

Most travelers do not possess a high proficiency in a languages other than their native language, and are not regularly accustomed to handling foreign currency. Therefore, having assistance during a transaction can be a critical asset to the traveling user, particularly if that user is alone or without another individual to look out for his or her best interests. The present invention discloses a new method of improving foreign transactions at the point of sale and method of teaching foreign language skills to a user through the use of a handheld electronic device. The method contemplates using the handheld device to assist the user in understanding the transaction costs, the required funds, the anticipated funds to be returned in the transaction, and to understand the merchant at the point of sale. The present method also contemplates improving one's foreign language skills by facilitating a transaction, where the both the translated local language and the transaction funds are displayed.

2. Description of the Prior Art

Devices have been disclosed in the prior art that relate to electronic handheld devices, translation devices, and methods involving transactions or interpreting foreign languages. These devices and methods generally relate to calculators and translation methods unrelated to point of sale transactions. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 6,438,524 to Shi, which discloses a foreign language translator that receives voice input from a user and repeats the same phrase in a chosen foreign language. The user is provided a selection of foreign phrases and languages to choose from stored in the device memory, while the device recognizes the voice of the user to determine the phrase to be repeated in the foreign language of choice. The user first trains the device in his native language, and thereafter speaks into the device for the same to correlate his or her input to a resultant foreign language stored in its memory. The Shi device, while providing a useful translation tool that functions based on voice input, is not suited for receiving visual input during a transaction to determine the amount of money being displayed or to calculate the required currency to change or hand over. The present invention contemplates a currency computer that operates across different currencies, receiving voice inputs and visual inputs in its determination of the required currency to present at the point of sale, and thereafter the expected change from the transaction.

Similar to the Shi device is U.S. Patent Publication No. 2003/0115068 to Boesen, which discloses a voice communication method and device for translating an input message into a different language to be interpreted by the user, whereby the system is housed within a nonocclusive earpiece. The earpiece comprises a plurality of microphones and a speaker, whereby the user can choose between different microphones for receiving different translations. The Boesen device, like the Shi device, fails to contemplate foreign currency and foreign language skills during a transaction and at the point of sale. The present invention contemplates a method and apparatus for allowing one to determine how much to pay and how much to receive in change during a transaction in a foreign country using voice, and image inputs.

Another device is U.S. Pat. No. 7,427,013 to Psencik, which is representative of the art of currency calculators in normal, everyday use where language is not a barrier and physical inputs are preferred. Psencik discloses a currency pad that includes numeric inputs and is capable of calculating sales tax at the point of sale. The Psencik device is very similar to most standard calculators, and does not contemplate operating in environments where a language barrier may exist or where there may be unfamiliar currencies in the transaction. The present invention allows a user to calculate unfamiliar currency and determine the required funds for a purchase, and thereafter the expected change in return, all based on voice and visual input.

Finally, U.S. Patent Publication No. 2012/0253782 to Ariga discloses a foreign language service assistant for customers interacting with sales agents where the two parties do not speak the same language. The service comprises an apparatus that acquires inputs from the user on a first and second article, translates the inputs, and outputs a presentation in a second language. The device is useful during transactions or locating articles within a catalog or large store. While useful for transactions or exchanges between individuals of dissimilar native languages, the Ariga device does not provide a point of sale device for interpreting transaction costs, transaction change, and a detailed breakdown of the currency required and expected to be received between peoples of different native languages.

The present method contemplates the use of a handheld electronic device that interprets auditory and visual inputs, and provides a user in with the translated inputs and a calculation of the funds required during a transaction at the point of sale. The method utilizes auditory input to recognize the funds required for a purchase, then utilizes either visual or auditory inputs to calculate the funds given to the merchant, and thereafter provides a visual confirmation of the anticipated funds to be returned by the merchant. The method translates the auditory inputs and provides visual representation of the translated language and the currency in the transaction for the user to readily recognize and understand the transaction as it occurs. Sufficient funds to provide to the merchant to cover the expense of the good or service is displayed to the user, whereafter the calculated return change is presented.

It submitted that the present invention is substantially divergent in design elements from the prior art, and consequently it is clear that there is a need in the art for an improvement to existing methods of translating between parties and facilitating point of sale transactions. In this regard the instant invention substantially fulfills these needs.

### SUMMARY OF THE INVENTION

In view of the foregoing disadvantages inherent in the known methods of translating audio input and calculating funds in a transaction now present in the prior art, the present invention provides a new method that can be utilized for providing convenience for the user when facilitating a user during an exchange of funds for goods or services in a language foreign to the user, while also educating the user through a foreign language translation tool in a point of sale environment.

It is therefore an object of the present invention to provide a new and improved translation method that has all of the advantages of the prior art and none of the disadvantages.

It is another object of the present invention to provide consumers in foreign countries with a tool that facilitates transactions at the point of sale to reduce mistakes, anxiety, and to make the transaction more efficient, despite a language barrier.

Another object of the present invention is to provide a translation method that utilizes auditory inputs to convert a foreign language into a native language, and further to process and calculate a transaction cost for the user in real-time at the point of sale.

Yet another object of the present invention is to provide a translation method that displays necessary currency required in a transaction and the anticipated return change, whereby the local denominations are shown for the user to readily collect and deliver to a merchant the required funds.

Another object of the present invention is to provide a translation method that can incorporate visual inputs by way of an image capture means for determining the amount of currency in the user's possession.

Another object of the present invention is to provide a translation method that teaches users foreign language skills and introduces the user to local currency, whereby the method serves as both a commerce tool and an educational tool.

Another object of the present invention is to provide a translation method that displays auditory inputs on a display means for the user in real-time, while also discerning from the auditory inputs a given transaction cost.

A final object of the present invention is to provide a translation method that utilizes a handheld electronic device to operate the method, whereby the device is deployed at the point of sale and can be set to translate a number of different local languages into the user's native language.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flow diagram of the user initialization procedures for setting the handheld device to a given set of languages and currencies prior to a transaction.

FIG. 2 shows a flow diagram showing the steps take to receive auditory inputs for a transaction cost.

FIG. 3 shows a flow diagram showing the steps take to receive auditory inputs and calculate a transaction return change based on funds provided to a merchant.

FIG. 4 shows a flow diagram of the steps taken to calculate the required funds in the transaction and how those required funds are communicated to the user.

FIG. 5 shows a flow diagram of the steps taken to calculate the amount of funds given to the merchant in the transaction based on auditory or visual input.

FIG. 6 shows a flow diagram of the steps take to calculate the expected return change in the transaction based on the merchant requested funds and the calculated funds given to the merchant.

FIG. 7 shows a flow diagram of the steps for tracking overall expenditures on a trip against a budget.

FIG. 8 shows a flow diagram of the steps taken to initialize and begin receiving and translating one local language into the user's native language, whereby the language can be displayed or spoken to the user through a handheld device.

FIG. 9 shows a view of an embodiment of a handheld device suitable for carrying out the disclosed method at the point of sale.

FIG. 10 shows a pictorial representation of the transaction as it occurs and as the present method is deployed.

### DETAILED DESCRIPTION OF THE INVENTION

Reference is made herein to the attached drawings. Like reference numerals are used throughout the drawings to depict like or similar elements of the disclosed translated transaction method. For the purposes of presenting a brief and clear description of the present invention, the preferred embodiment will be discussed as used for translating for and teaching to a user in a foreign language the required funds in a transaction at the point of sale, wherein the funds required, anticipated return change, and the merchant's language are translated and calculated into terms readily recognizable for the user. The figures are intended for representative purposes only and should not be considered to be limiting in any respect.

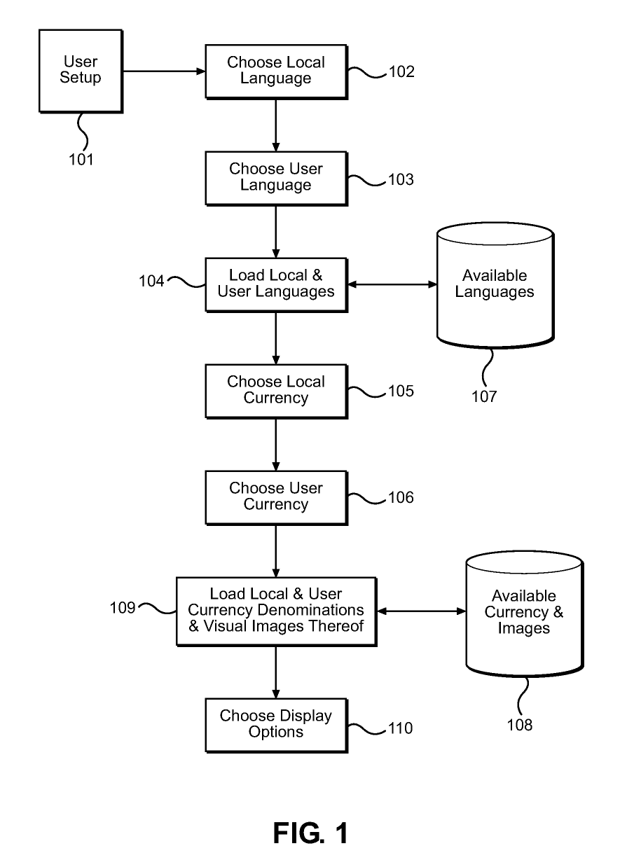

Referring now to FIG. 1, there is shown a flow diagram outlining the method steps of the present invention for initializing the handheld device for use in a transaction in a foreign country. The present method involves deploying a handheld device that is capable of receiving auditory (and optionally visual inputs), for the purposes of determining the transaction costs, the returned change to be received from a merchant, and to assist the user in the transaction where the user does not speak the local language or readily recognize the local currency. It is contemplated that an electronic handheld device will be deployed at the point of sale when a user is purchasing items (food, services, goods, etc.). The handheld device receives auditory inputs from both the user and the merchant after the handheld device has been initialized and setup to receive a specific local language. The local language is translated by the device, displayed for the user, and further the details of the transaction are calculated to assist the user paying the correct funds and receiving the correct change from a merchant in a foreign country. The method assists exchanges and transactions in a non-native country, while also teaches the user some foreign language skills and provides knowledge about the local currency.

To initialize the handheld device, several steps are taken and are shown in FIG. 1. The user first sets up 101 a handheld device through a series of user settings such that the local language and the user's native language are known prior to a transaction and before the method steps assisting the transaction are taken. Within a user setup interface 101, the user chooses the anticipated local language 102 to be received by the handheld device and translated by the present method. The user then chooses his native language 103, or a language in which he would like to be translated for his understanding. The languages initialize the method of translating and provide an anticipated language to be received through auditory input, whereby the chosen native 103 is that which will be translated for the user and provided via the handheld display means or via audio translation in real-time. Real-time translation is contemplated and assists the user's understanding of the transaction and the local language itself, but such translation is not required by the present method. Real-time translation tools and methods are well known in the art, and the present method contemplates use of these methods in facilitation of its own purpose: improving transaction transparency and understanding at the point of sale in a foreign country.

Once the local 102 and user 103 languages are chosen, the user can then set the local currency 105 that will be utilized in the transaction and the user's native currency 106. The local currency 105 can differ with respect to the country being traveled and is not necessarily tied to the chosen local language 102, therefore a database of countries and their local currency is provided. A map of the world may be provided for the user to choose a country, and then specific the language of choice and the currency being used. Some countries have multiple languages and accept different currencies; therefore careful choice of each is required prior to the user reaching the point of sale. The handheld device loads the languages and the currencies chosen by the user. The languages and the currencies are loaded 104 from within computer storage 107, 108 on the handheld device (e.g. from a handheld device hard drive), or alternatively the handheld device may comprises an antenna for receiving wireless communication. The wireless communication link may be utilized for device to download the necessary language and currency from an external server having the same stored on its own computer storage means. The local currency can also be visualized 109 once loaded for the user to interrogate and study the same while getting accustomed thereto.

Once the currencies and languages are chosen, the user can choose how the transaction will be displayed 110 to him at the point of sale. Options contemplated include real-time text translation of the foreign language into the user's language, audible translation of the foreign language into the user's language, and further display options for showing the local currency and transaction calculation. During the transaction, the required funds and those to be returned are calculated. The user can choose to display the required funds on the handheld device display means in the highest calculated denominations (e.g. showing one euro coin and coins for change in the highest possible denominations to make exaction change). The visual representation of the required funds in the local currency allows the user to choose the correct change to be given, and further for the user to learn the local currency (i.e. its value, its denominations, etc.). The user can also setup a budget in local and native currency to track spending over multiple transactions, and show the user's spending in local terms or in his or her own currency.

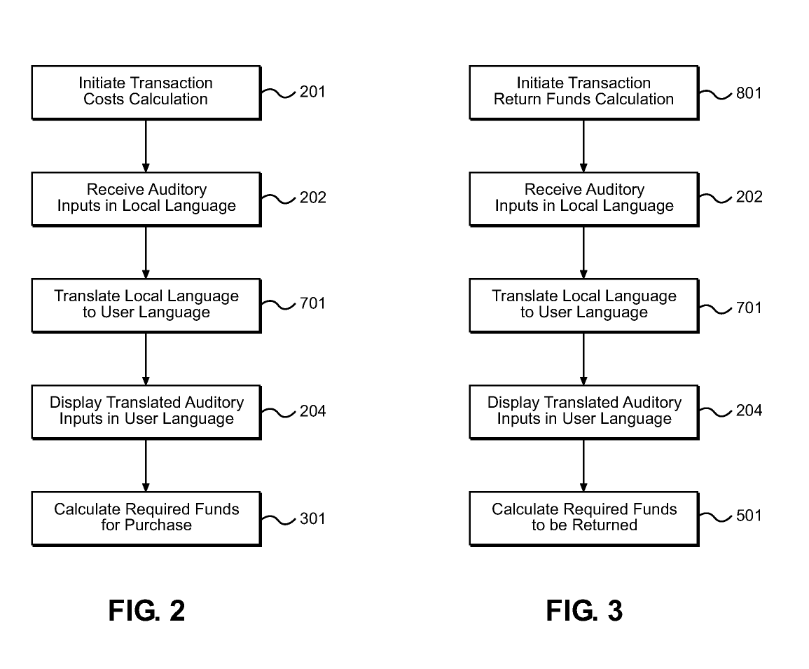

Referring now to FIG. 2, there is shown a flow diagram outlining the steps taken by the present method to initiate receipt of auditory inputs for calculation of transaction costs 201 in local currency at the point of sale. These steps represent a master routine that initiates subroutines to calculate required funds, recognize received audio inputs 202 from in a given language, and then translate 701 that language into the user's chosen language. The user's display preferences are also exercised during this input stage, wherein the transaction has begun and the user is receiving a request from a merchant for a given amount of funds for goods desired at the point of sale.

Upon approaching the merchant at the point of sale, the user initiates the transaction costs calculation 201 by initiating the handheld device. This begins the receipt of auditory inputs 202 to the handheld device in the merchant's local language, which is the same as the user chose as the local language. The merchant's language is received by a microphone, wherein the received input is transformed into digital format to be operated upon and translated 203 via a translation algorithm. Each word of the merchant's input is parsed and recognized in the local language, whereafter the recognized words and phrases are translated into the user's native language (that language chosen during initialization). The translated language is optionally displayed 204 to the user in real-time via the handheld display means (e.g. digital display screen), and from the received inputs from the merchant, the transaction costs are calculated 301 via a cost subroutine.

After the costs have been calculated 301 and the user knows the required currency to provide to the merchant, steps are taken to determine the anticipated change to be received in the transaction based on the funds given to the merchant to cover the costs. Referring to FIG. 3, the steps taken to provide the user with the anticipated return change are shown. The user initiates 801 the handheld device to begin taking inputs 202 as to the funds given to the merchant. Once the funds known to be given to the merchant are known, the anticipated change is calculated.

At this stage, calculations are made based on the funds provided minus the funds necessary for the transaction. The funds provided are determined based on the inputs 202 from the user, whereby the local currency given to the merchant is determined. The return change anticipated from the merchant is calculated 501 and visualized on the handheld device display, wherein the amount of funds is shown in the largest denominations possible to make the given amount. During this process, the translated 701 auditory inputs from the merchant are displayed 204 for the user to recognize the merchant's inputs.

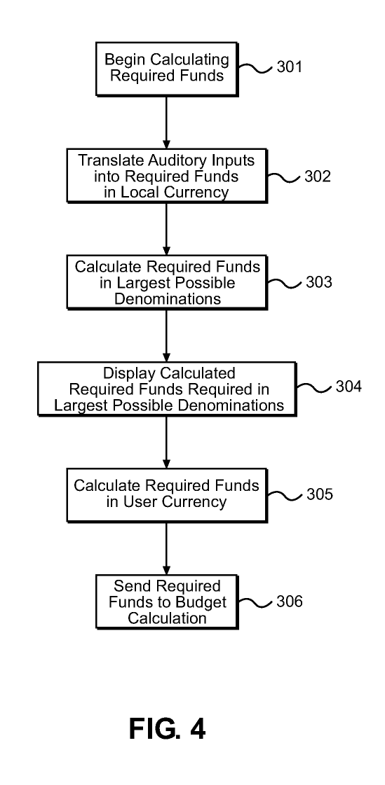

Referring now to FIG. 4, there is shown the subroutine and steps utilized to calculate the required funds 301 in the transaction. In order to provide the user with a breakdown of the costs of a purchase, the merchant's voice inputs are required, whereby these inputs are interpreted, translated 302, and transformed into visual inputs for the user such that he or she can choose the an minimum amount of funds to provide to the merchant. The handheld device is utilized to translate 301 auditory inputs into the required funds for the transaction in the local currency. The required funds are calculated 303 and shown 304 to the user in the largest possible denominations. The required funds can then be calculated 305 in terms of the user's native currency, and thereafter be utilized in a budget calculation 306 to track overall spending of the traveling user. Overall, the method transforms a merchant's request for a given amount of funds into a visual signal to the user, whereby the user can quickly realize the costs and retrieve the necessary funds at the point of sale.

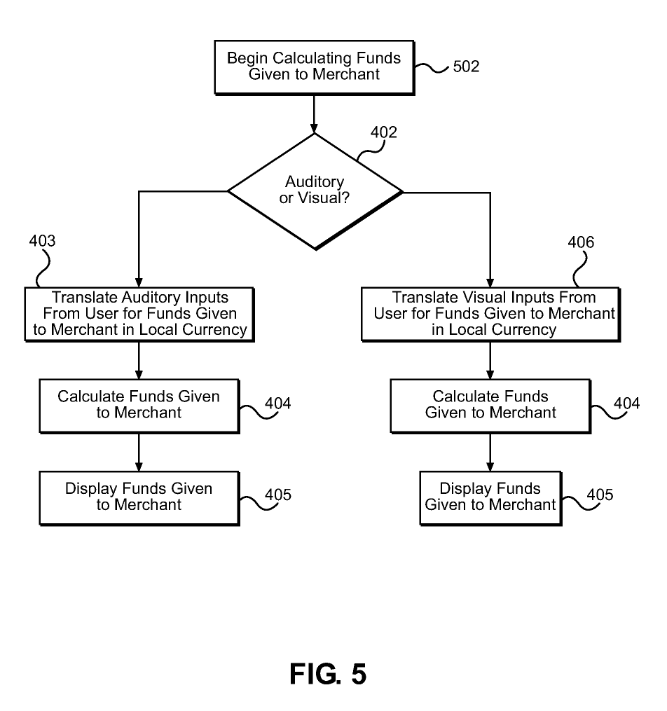

Referring now to FIG. 5, there is show a diagram outlining the different means of calculating 502 the funds actually given to the merchant in the transaction. Once the funds known to be given to the merchant are known, the calculated cost of the transaction can be deducted from that amount to provide an estimate of the change to be received in the transaction. To determine the funds given to the merchant 502, the handheld device is adapted to calculate the amount based on either auditory or visual inputs 402 from the user to the handheld device. The user can speak into the handheld device in his or her language, which is recognized 403 and then transformed 404 into an amount of funds. Alternatively, the user can utilize an image capture means (e.g. a camera) on the handheld device to capture an image 406 of the funds given to the merchant. In this way, the user can hold several coins or place them on a counter and snap a photograph thereof. The photograph is analyzed 406 and compared against the local currency to determine the amount given in total. Once the total amount is calculated, the anticipated change is then calculated. The amount actually given to the merchant is calculated 404 and displayed 405 for the user to verify the amount.

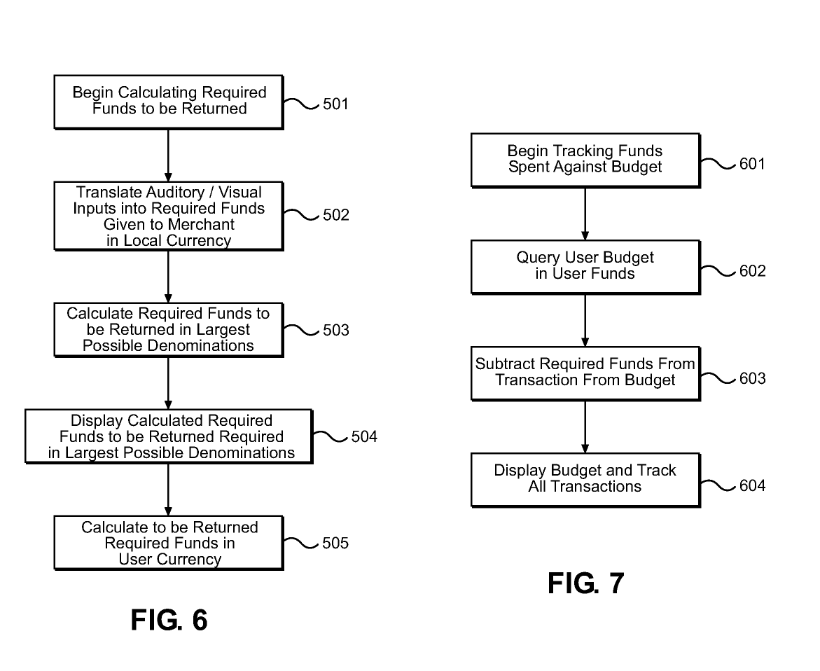

Referring now to FIG. 6, the method steps of determining the return funds from the merchant 501 are shown. Once auditory and visual inputs are received 502 via the handheld device. The amount of funds given to the merchant is determined 502 based on either audible inputs from the user or the user may deploy an image capture means on the handheld device to have the funds in his or her hand calculated. The user's audible inputs are translated, or alternatively the visual inputs are analyzed to determine the actual amount given to the merchant. The funds to be returned are calculated 503 based on the funds given to the merchant subtracted from the purchase price, whereafter the return funds are displayed for the user. These funds can then be calculated in the user's currency 505 as desired.

The visual representation of the funds in the local currency allows the user to anticipate the return change and how it will look, whereby fraud on the part of the merchant is deterred and the user understands what to expect in return for his payment. The returned funds can also be calculated and shown in the user's chosen currency, whereby the exchange rate against the local currency is used to convert the amount into the user's currency.

Referring now to FIG. 7, the budgeting ability of the present method is shown, whereby purchases can be tracked and subtracted from an overall budge. The user first initiates the budget tool 601, which tracks the funds spent and allows those funds to be subtracted 603 from a budget determined by the user. During the tracking process, the balance of the budget is queried 602, from which the latest transaction is subtracted 60 therefrom. At any time the user can display 604 the budget in terms of local or user currency, as desired. This helps the user track expenditures over a vacation or extended trip, and prevents budget shortfalls or over-spending.

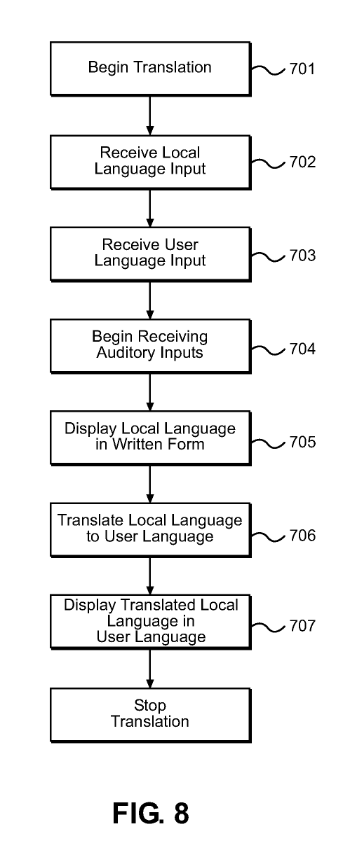

Referring now to FIG. 8, there is shown a contemplated method of translating 701 auditory inputs via the handheld device. It is not desired to disclose a new or novel means of interpreting sound input and transforming it into digital form, nor is it desired to disclose a new means of translating voice inputs. Rather, it is desired to utilize known means of voice translation as a means to provide feedback to the user during the steps outlined in the process of facilitating transactions between merchants and travelers at the point of sale. The contemplated method involves receiving 704 auditory input in a local language, whereby the local language 702 and the user's language 703 are chosen prior to use. The auditory inputs are received 704 through a microphone in the handheld device, transformed into digital format and displayed 705 on the handheld device display means. The inputs are also translated 706 into the user's language and displayed 707 on the display means in conjunction with the native language. In this way, the user can see the native language and his or her own language as it is received via auditory input, whereby the user can slowly learn phrases and the local language as a whole.

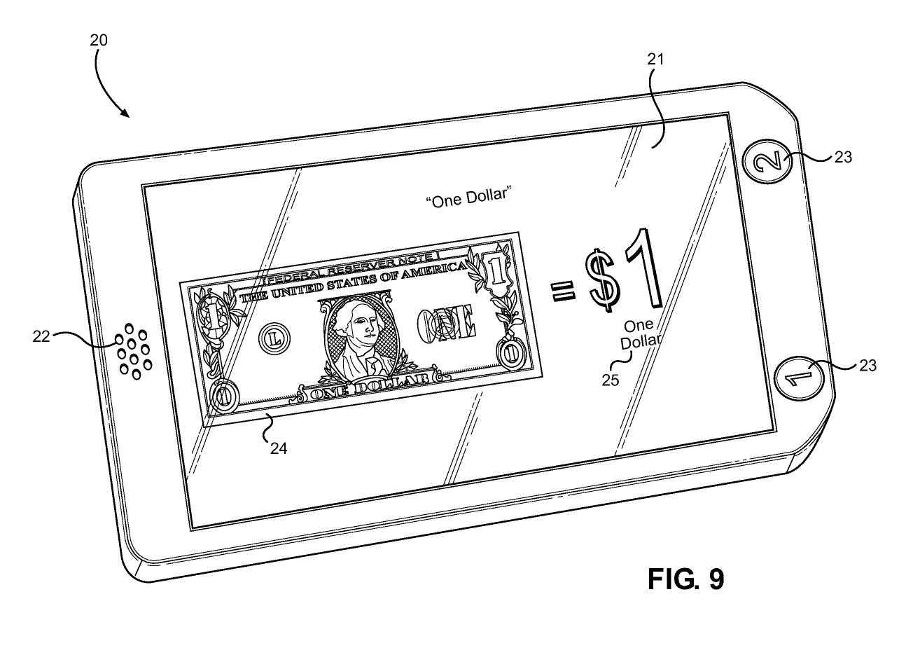

Referring now to FIG. 9, there is shown an illustrative embodiment of the handheld device 20 of the present invention, wherein the handheld device 20 is an electronic device having a processing means (e.g. CPU or equivalent), computer memory, computer storage, and various inputs and outputs. The inputs include a microphone 22, an optional image capture means (e.g. a camera), and at least one input button 23 for making selections on the device. Outputs include a display screen 21, which may also form an input if a touchscreen embodiment is deployed. Overall the handheld device operates as a translation and transaction tool between parties speaking different languages, whereby the device is deployed at the point of sale and utilizes auditory or visual inputs as a means to inform the consumer of the transaction costs and anticipated return change, while also acting as a translation tool.

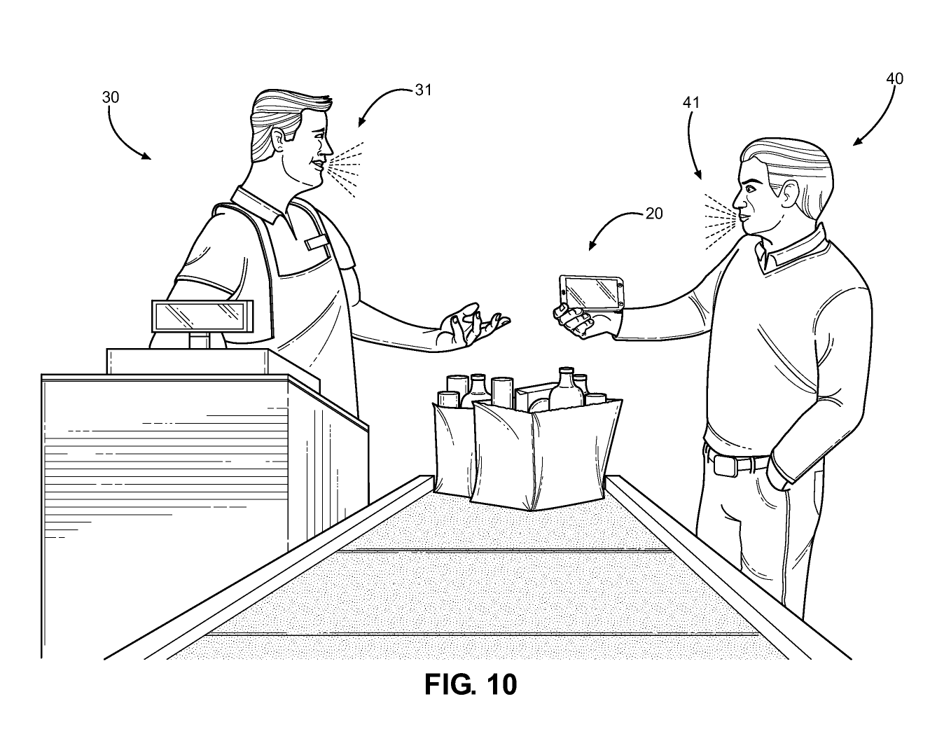

As shown in FIG. 10, the handheld device 20 is activated at the point of sale where goods are being purchased. Voice inputs 31 from the merchant 30 and voice inputs 41 from the consumer 40 are operably captured by the device 20, translated and then communicated to the user 40. The user chooses which part of the transaction is occurring by initiating the required funds steps, the delivered funds steps, and thereafter the anticipated change steps and budgeting steps. During these steps, the user can visualize the device 20 to see real-time translations for assistance while navigating in a foreign country and learning the language.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of facilitating a transaction at the point of sale in a foreign country, comprising the steps of:
employing an electronic handheld device between a buyer and seller at a point of sale;
receiving auditory inputs through said handheld device for a bill amount in local currency;
calculating required local currency for payment of said bill amount based on said voice inputs using said handheld device;
displaying said required local currency to said buyer on said handheld device;
paying said seller a payment amount in local currency;
receiving auditory inputs through said handheld device for said payment amount in local currency from said buyer;
calculating anticipated returned change in local currency based on said bill amount minus said payment amount;
displaying said anticipated returned change on said handheld device.

2. The method of claim 1, further comprising the steps of:
calculating the largest denominations of said local currency to equal said required local currency;
displaying said largest denominations of said required local currency on said handheld device.

3. The method of claim 1, further comprising the steps of:
calculating the largest denominations of said local currency to equal said anticipated local currency;
displaying said largest denominations of said required anticipated currency on said handheld device.

4. The method of claim 1, further comprising the steps of:
converting said local currency into a user currency;
displaying said user currency on said handheld device.

5. The method of claim 1, further comprising the steps of:
tracking payments over multiple transactions;
subtracting said payments from a preset budget.

7. The method of claim 1, further comprising the steps of:
converting said auditory inputs into visual sentences;
displaying said visual sentences on said handheld device.

8. The method of claim 1, further comprising the steps of:
translating said auditory inputs into a user language;
displaying translated auditory inputs on said handheld device.

9. A method of facilitating a transaction at the point of sale in a foreign country, comprising the steps of:
employing an electronic handheld device between a buyer and seller at a point of sale;
receiving auditory inputs through said handheld device for a bill amount in local currency;
calculating required local currency for payment of said bill amount based on said voice inputs using said handheld device;
displaying said required local currency to said buyer on said handheld device;
paying said seller a payment amount in local currency;
receiving visual inputs through said handheld device for said payment amount in local currency from said buyer;
calculating anticipated returned change in local currency based on said bill amount minus said payment amount;
displaying said anticipated returned change on said handheld device.

10. The method of claim 9, further comprising the steps of:
calculating the largest denominations of said local currency to equal said required local currency;
displaying said largest denominations of said required local currency on said handheld device.

11. The method of claim 9, further comprising the steps of:
calculating the largest denominations of said local currency to equal said anticipated local currency;
displaying said largest denominations of said required anticipated currency on said handheld device.

12. The method of claim 9, further comprising the steps of:
converting said local currency into a user currency;
displaying said user currency on said handheld device.

13. The method of claim 9, further comprising the steps of:
tracking payments over multiple transactions;
subtracting said payments from a preset budget.

14. The method of claim 9, further comprising the steps of:
converting said auditory inputs into visual sentences;
displaying said visual sentences on said handheld device.

15. The method of claim 9, further comprising the steps of:
translating said auditory inputs into a user language;
displaying translated auditory inputs on said handheld device.
